(19) United States
(12) Patent Application Publication
(10) Pub. No.: US 2008/0084390 A1
(43) Pub. Date: Apr. 10, 2008

(54) Remote Control System for use with a Glove

(75) Inventor: Aubrey Jones, South Orange, NJ (US)

Correspondence Address: JONES PRODUCT INNOVATIONS, LLC, 109 PROSPECT PLACE, SOUTH ORANGE, NJ, 07079, US

(73) Assignee: Aubrey Jones, South Orange, NJ (US)

(21) Appl. No.: 11/778,007

(22) Filed: Jul. 13, 2007

Related U.S. Application Data
(60) Provisional application No. 60/849,459, filed on Oct. 5, 2006.

(51) Int. Cl. G09G 5/08

(52) U.S. Cl. 345/158

(57) ABSTRACT

Methods and systems consistent with the present invention provide a wired or wireless remote control unit engineered to fit over a gloved hand and having large buttons capable of being pressed through gloved finger tips. Accordingly, a user is able operate a wired or wireless remote while wearing gloves and keeping their hands warm.

### FIELD OF THE INVENTION

The present invention generally relates to remote control units and more particularly to remote control units for use while wearing gloves.

### BACKGROUND

Over the past several decades there has been widespread adoption by consumers of various types of audio/video players. Devices such as compact disc (CD) players, radio receivers, mp3 players, digital media players, and other similar audio/video players have become commonplace in many households. Many of these audio/video players are designed to be operable by built-in control panels, which allow users to control different functions such as adjusting the sound volume, stopping a track, rewinding a track, fast forwarding a track, etc. However, the built-in control panel is inconvenient when a audio/video player is not conveniently accessible by the user. In view of this disadvantage, remote control units have been extensively developed. Using a remote control unit, a user can perform a variety of operations such as switching to a different track on a DVD playing in a DVD player, or changing the volume of a media player, even when the player is not conveniently accessible.

In the past, when a person wearing gloves or mittens wished to use a remote control unit while wearing the glove, it has been necessary to remove the glove completely to use the remote control or other electronic device requiring manual dexterity. Accordingly, there is a need for an improved remote control and glove system which allows easy operability of the remote control or other electronic device without having to remove the glove. This problem is particularly relevant where the conditions are cold, wet or otherwise unpleasant and it would be uncomfortable and unwieldy to remove the glove or mitten.

### SUMMARY

Methods and systems consistent with the present invention include a wired or wireless remote control unit engineered to be coupled to, affixed to, or fit over a gloved hand, or incorporated within a glove or mitten and having large buttons capable of being pressed through or within gloved or covered finger tips. Accordingly, a user is able operate a wired or wireless remote while wearing gloves or mittens or other hand covering and keeping their hands warm.

In one embodiment consistent with the present invention, remote control unit is affixed to the palm of the glove by a strap, belt, button, velcro, glue, snap, zipper or some other coupling device or method. In another embodiment consistent with the present invention, the remote control unit is affixed to a side posterior to the palm by a strap, belt, button, velcro, glue, snap, zipper or some other coupling device or method. In yet another embodiment consistent with the present invention, the remote control unit is integrated in the glove. A control pad for the remote control unit is enmeshed in the fabric of the glove. In one embodiment consistent with the invention, the control pad is enmeshed in the palm of the glove. In another embodiment of the invention, control pad is enmeshed in the side of the glove posterior to the palm.

In still another embodiment consistent with the present invention where the remote control unit is integrated with the glove, buttons for operating the remote control unit are located at the tips of the fingers and thumbs on the anterior or palm side of the glove. In another embodiment of the invention, the buttons for operating the remote control unit are located at the tips of the fingers and thumbs on the posterior side of the glove.

The remote control may be wired or wireless. Wireless transmission mediums include radio frequency, infrared, and any other equivalent wireless transmission medium.

Other systems, methods, features, and advantages consistent with the present invention will become apparent to one with skill in the art upon examination of the following figures and detailed description. It is intended that such additional systems, methods, features, and advantages be included within this description and be within the scope of the invention.

### BRIEF DESCRIPTION OF THE DRAWINGS

The accompanying drawings, which are incorporated in and constitute a part of this specification, illustrate an implementation of the invention and, together with the description, serve to explain advantages and principles consistent with the invention. In the drawings,

FIG. 1 illustrates a glove remote control system consistent with a first embodiment of the present invention

FIG. 2 illustrates a glove remote control system consistent with a second embodiment of the present invention;

FIG. 3 illustrates a glove remote control system consistent with a third embodiment of the present invention;

FIG. 4 illustrates a glove remote control system consistent with a fourth embodiment of the present invention;

FIG. 5 illustrates a glove remote control system consistent with a fifth embodiment of the present invention;

FIG. 6 illustrates a glove remote control system consistent with a sixth embodiment of the present invention;

FIG. 7 illustrates a glove remote control system consistent with a seventh embodiment of the present invention; and

FIG. 8 illustrates a glove remote control system consistent with an eighth embodiment of the present invention.

### DETAILED DESCRIPTION

As used herein, the term “glove” is meant to include any form of hand covering, including, but not limited to, gloves, mittens, hand warmers, pockets, mitts, bandages, and wraps.

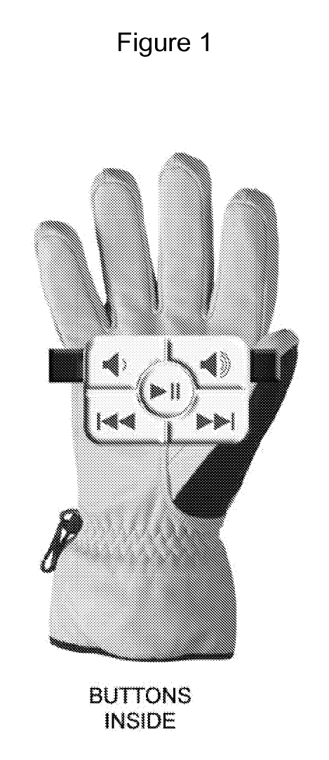

In one embodiment consistent with the present invention, a glove remote control unit is attached to a glove as illustrated in FIG. 1. The glove remote control unit comprises a control casing, circuitry for generating signals to operate a media device such as an audio player, enlarged buttons for operation of the remote control while wearing gloves, and an adjustable strap or flexible band extending at both ends of the control casing in fully or semi-closed loop to be worn over a gloved hand or any place the user desires. Operation of this device may include transmitting or receiving commands, transmitting or receiving information, transmitting or receiving audio signals, or transmitting or receiving video signals for display. Using the glove remote control unit, a user may operate a media player through a received in the media player with removing the user's gloves, thus keeping the user's hands warm in frigid weather. The glove remote control unit also allows the user to easily carry the (receiver) unit along, storage and preventing from falling on the ground in use.

Methods and systems consistent with the present invention utilizes a belt or strap similar to that of a wrist watch or armband. The belt or strap may be an adjustable or flexible band extending at both ends of the control casing in fully or semi-closed loop to be worn over a gloved hand or any place the user desires. This strap or belt may be a chain, belt, expansion or foldable structure, a retractable mechanism for pull and extension effects, or a buckle and shackle with multiple fixing holes.

The glove remote control unit may transmit information to and receive information from the controlled device, such as a media player, by either a wired or wireless medium. The remote control unit casing and buttons can be in any size or dimension whether in a circular, square or any irregular shape desired such as in the three versions provided. The remote control casing can be controlled by pressing its large buttons through a gloved hand and is not limited to a ball, roller, or joystick integrated into the control device. Functions may include the operation of commands and data transmission or reception and transmission of remote controlled message by means of infrared or radiation frequency transmissions. The controlled device may also be an electronic home appliances, toys, education, and other domestic systems or industries.

The glove remote control unit may control audio or video functions with a 5-button infrared transmitter functions: play/pause, next track/fast forward, previous track/rewind, volume up, and volume down. The glove remote control unit may include other buttons such as a hold button. The said transmitter unit sends control signals to the receiver unit, which may be an MP3 player, cell phone, or any other consumer or industrial electrical product.

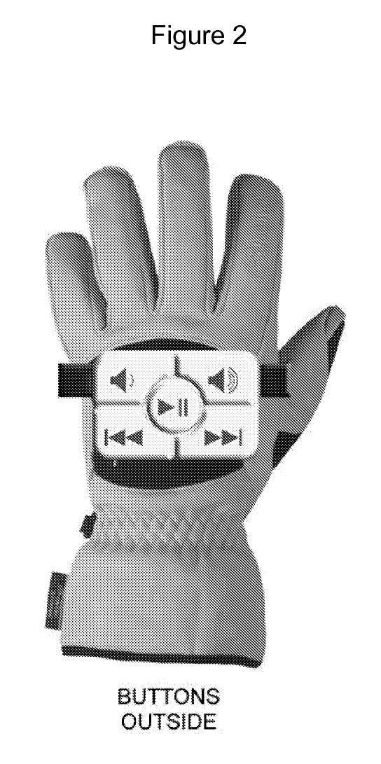

In another embodiment consistent with the present invention, the glove remote control unit is located on the side of the posterior to the palm, as illustrated in FIG. 2.

The controls of the glove remote control unit may also be embedded or integrated inside, or on any surface of a glove that includes on top, inside the palm, or on the finger tips. This type of control device glove can be in any size or dimension whether in a circular, square or any irregular shape desired.

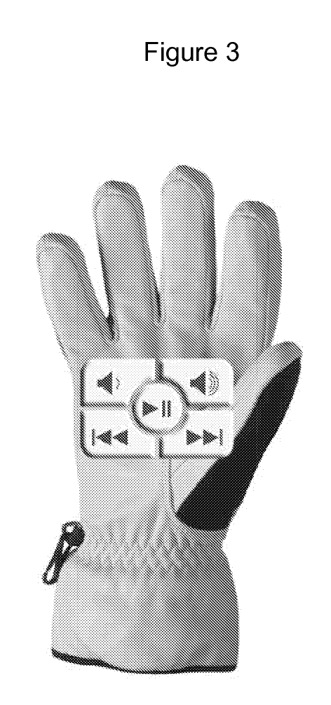

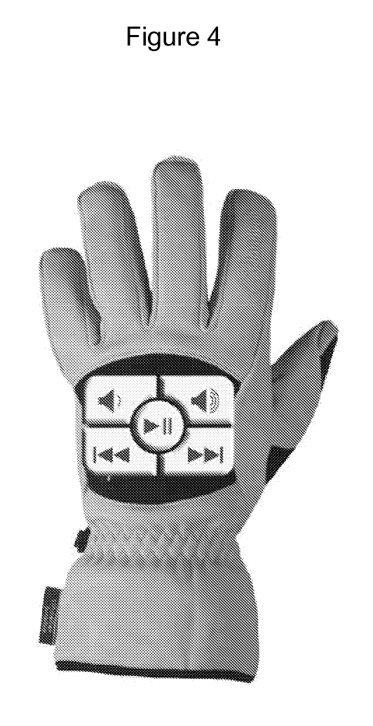

In yet another embodiment consistent with the present invention, the remote control unit is integrated in the glove. A control pad for the remote control unit is enmeshed in the fabric of the glove. In one embodiment consistent with the invention, the control pad is enmeshed in the palm of the glove, as illustrated in FIG. 3. In another embodiment of the invention, control pad is enmeshed in the side of the glove posterior to the palm, as illustrated in FIG. 4.

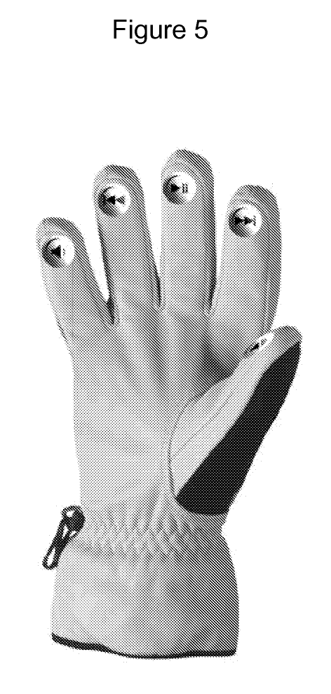

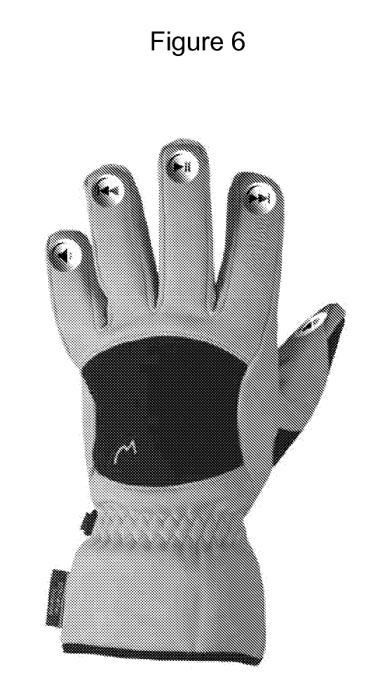

In still another embodiment consistent with the present invention where the remote control unit is integrated with the glove, buttons for operating the remote control unit are located at the tips of the fingers and thumbs on the anterior or palm side of the glove, as illustrated in FIG. 5. In another embodiment of the invention, the buttons for operating the remote control unit are located at the tips of the fingers and thumbs on the posterior side of the glove, as illustrated in FIG. 6.

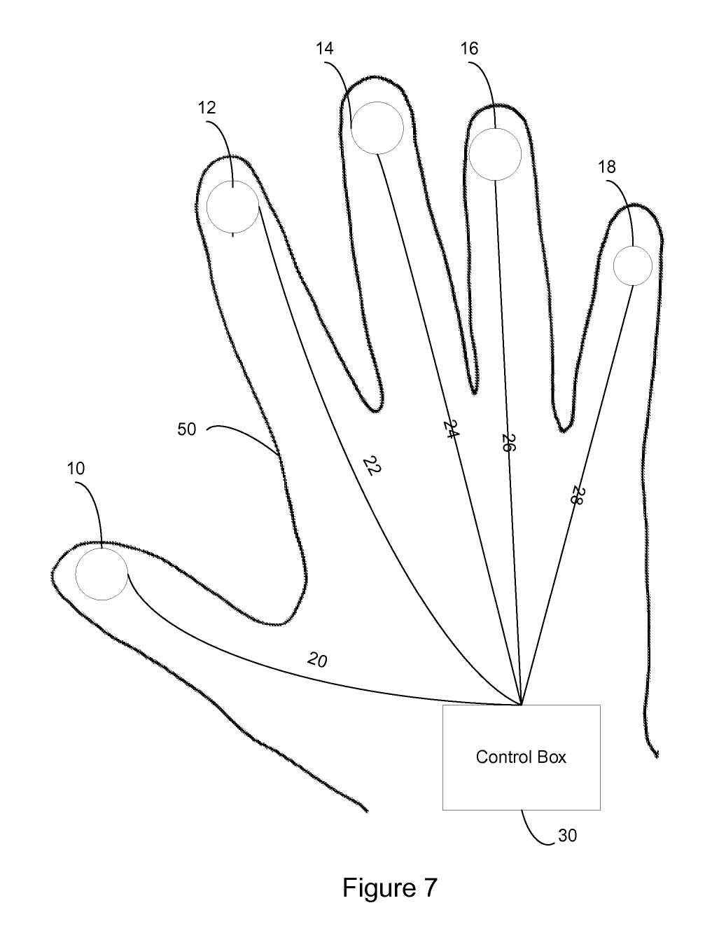

FIG. 7 illustrates an interior view of the gloves illustrated in FIG. 5 or 6. Buttons 10, 12, 14, 16, and 18 are operatively connected to control box 30 by wires 20, 22, 24, 26, and 28, respectively. Wires 20, 22, 24, 26, and 28 are flexible and may be wire of copper or any other conductive material. Alternatively, wires 20, 22, 24, 26, and 28 may be fiber optic wires. Control box 30 processes signals received from the buttons 10, 12, 14, 16, and 18, and transmits the corresponding command to a receiver (not shown). Control box 30 may include a power supply and transmission antenna. Control box 30 may further be connected to the receive by a wire (not shown). The wires 20, 22, 24, 26, and 28, buttons 10, 12, 14, 16, and 18, and control box 30 may be enmeshed in the fabric of glove 50.

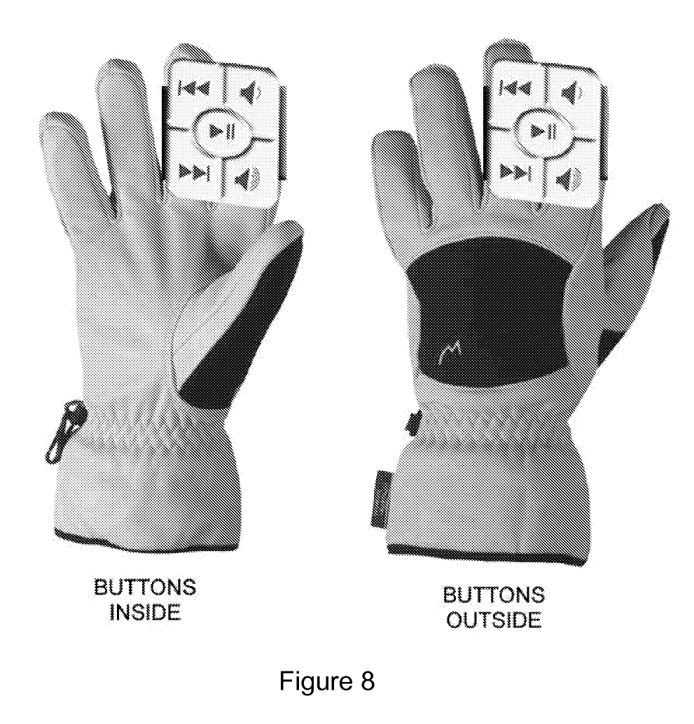

FIG. 8 illustrates yet another embodiment consistent with the present invention that utilizes a belt or strap around the fingers of the glove. The belt or strap may be an adjustable or flexible band extending at both ends of the control casing in fully or semi-closed loop to be worn over one, two, three, or four of the glove fingers. This strap or belt may be a chain, belt, expansion or foldable structure, a retractable mechanism for pull and extension effects, or a buckle and shackle with multiple fixing holes.

In one embodiment consistent with the present invention, the glove remote control unit is located on the side of the palm of the glove. In another embodiment consistent with the present invention, the glove remote control unit is located on the side of the posterior to the palm.

While there has been illustrated and described embodiments consistent with the present invention, it will be understood by those skilled in the art that various changes and modifications may be made and equivalents may be substituted for elements thereof without departing from the true scope of the invention.

What is claimed is:

1. A remote control system, comprising:
a hand covering;
a first switch, coupled to a first portion of the hand covering;
a second switch, coupled to a second portion of the hand covering.

2. The system according to claim 1, wherein the first portion of the hand covering is located adjacent to a finger section of the hand covering.

3. The system according to the claim 1, wherein the first switch is a play button.
